(19) United States
(12) Patent Application Publication
(10) Pub. No.: US 2005/0050574 A1
(43) Pub. Date: Mar. 3, 2005

(54) Apparatus for viewing a satellite transmitted sports event televised live via a dish network on towards an LCD (liquid crystal display) of rectangular contour, while inside a sports stadium

(76) Inventor: Edgar Vicente Chiquin, Austin, TX (US)

Correspondence Address: Edgar Chiquin, 800 POLO CLUB DRIVE, AUSTIN, TX, 78749, US

(21) Appl. No.: 10/098,607

(22) Filed: Mar. 18, 2002

(51) Int. Cl. G09G 5/00; H04N 7/18; H04N 7/173; H04N 7/16; H04N 5/44; G06F 3/00; G06F 13/00; H04N 5/445

(52) U.S. Cl. 725/77; 725/133; 725/153; 345/3.1; 348/725; 725/37

(57) ABSTRACT

An LCD display similar to an automobile's television screen, 5×4×1 which is mounted on the back of a seat's head rest or on a flip-down screen that rests from the roof of the automobile. This LCD television screen is mounted behind the seat of a person that is seated in front of the viewer wanting to view the satellite transmitted sports event. The screens are attached to the back of the seats with a strong Velcro adhesive. The LCD screens are connected to receivers that are provided by a satellite-based company, which typically installs a small dish and receiver towards any television at home or in a business. The receiver transmits satellite signal to the particular LCD screen via RCA cables, which input and output on both the LCD screen, and receiver. The receivers are inter-connected to the LCD screens. Remote is attached with Velcro to top of receiver.

Apparatus for viewing a satellite transmitted sports event televised live via a dish network on towards an LCD (Liquid crystal display) of rectangular contour, while inside a sports stadium.

An LCD (Liquid crystal display) of rectangular contour similar to an automobiles' television screen of which is typically 5×4×1, and is mounted on the back of the seats' head rest or on a flip-down screen that rests from the roof of the automobile. This LCD television screen is mounted directly behind the seat of a person that is seated in front of the viewer wanting to view the satellite transmitted sports event. The LCD screens are positioned inside the stadium behind all of the seats that are in a particular designated section for this apparatus. The screens are attached to the back of the seats with a strong type of Velcro adhesive. The LCD screens are positioned behind the designated seats for the purpose of viewing them in a normal seated position, while staying attentive to the game inside the stadium at the same time. The LCD screens are connected to receivers that are provided by a satellite-based company, which typically installs a small dish and receiver towards any televisions at home or in a business. In this case, the LCD television screens allow the sports fan to view programming that is offered on this satellite network. The receiver transmits a satellite signal to the particular LCD screen via RCA cables, which input and output on both the LCD screen, and receiver. The receivers are connected to every LCD screen in order for the viewer to choose his or her sports-related programming. The receiver is positioned on the floor under the viewers seat. The person viewing the LCD screen can change the programming simply by picking up the remote (attached to the top of the receiver with Velcro), and changing the channel to another sports channel made available to them (The receiver box is pre-programmed so the viewer may only watch sports related channels.) The viewer must reach with the remote under their seat in order for the signal to appropriately function. The viewer may choose to view the sports event that is being telecasted live in another sports stadium, or may choose to watch the telecasted game on the LCD screen he or she is attending live.

References

| | | | | | |
|---|---|---|---|---|---|
| 5737698 | April 1998 | Gabrelian et al. | 5777588 | July 1998 | Woodgate et al. |
| 5752180 | May 1998 | Guo et al. | 5784129 | July 1998 | Konuma et al. |
| 5793258 | August 1998 | Lange. | 5825337 | October 1998 | Wiseman et al. |
| 5805975 | September 1998 | Green, Sr. et al. | 5874929 | February 1999 | Opower et al. |
| 5898455 | April 1999 | Barakat et al. | 5886675 | March 1999 | Aye et al. |

### BACKGROUND OF THE INVENTION

### 1. FIELD OF THE INVENTION

This invention concerns apparatus for viewing a satellite transmitted sports event that is televised live via a dish antenna on towards an LCD (Liquid crystal display) of rectangular contour, while inside a sports stadium specifically, the LCD mounted on the back of a sports stadium seat.

### 2. DESCRIPTION OF THE PRIOR ART

In many sports stadiums, the game is televised on a very big screen that is mounted for example in baseball stadiums, on the 400 ft. wall mark right where the statistics of each player, the score, and many other information about the game that is being played, and the score of the games that are being played at other stadiums. In basketball and other in-door sport facilities, the big screen is mounted on the ceiling of the stadium, or sometimes on the upper corner. Sports is an event that whenever the action is being played inside the stadium, many people want to be a part of the entire league of teams, and therefore keep track of the other scores, statistics, and any information that is from other teams that are involved in the sports league.

### 3. SUMMARY OF THE INVENTION

The above and other beneficial objects and advantages are accomplished in accordance with the present invention by a viewer that chooses to purchase in agreement, a pass to view a telecast sports event either on the sports channel provided to them, or on the channel that is telecasting live the game that they are attending said apparatus comprising:
a) a game of which seats are in designated areas that include LCD monitors that are typically 5×4×1 in dimensions and are mounted on the upper back of the stadium seat,
b) a game of which is televised normally in a sports stadium on a big screen that creates a variety of distinctions from the present invention such as: position of the big screen television inside the sports facility either being too high for the audience to keep looking at and therefore just deciding to look at the game; resolution of the big screen television is very bad simply because the players are portrayed on the big screen as too big and the field of focus is easily lost because the court, or field is too up-close and therefore creates a narrow screen; clarity, color, and contrast, are also taken in to consideration because they are all creating the image that is being televised to the audience as too blurry or too narrow for anyone to truly enjoy,
c) a game of which viewers attending a sports event in a stadium, are given the opportunity to view the game they attended, right up in front of them with high resolution in the present invention. The viewer also gets the opportunity to view the game they are attending live on an LCD screen because many sports facilities don't even televise the game on a big screen television inside the stadium and also listen to the live play-by-play sports commentator, that would not be possible available in the stadium setting,
d) a game of which viewers attending a sports event in a stadium, are given the opportunity to choose whatever sports telecast they want to enjoy while attending the live stadium setting simply by changing the channel on the said receiver that is positioned comfortably under their seat,
e) a televised sports event that is broadcasted through a satellite signal on towards an installed small dish on to the LCD screen, and then towards a broadcast center and finally back to the satellite,
f) a series of LCD screens connected with coaxial cables to one another in order for the receiver to transmit the audio/visual signal with only one paid satellite subscription by slaving the receivers to one another,
g) a strong bonding fastener that works similarly to Velcro, and connects the hook and loop actions of the fastener creating a bound of mushrooms that stick together in order to bond the LCD screen to the upper back of the stadium seat,
h) the ability for the viewer to receive statistics such as team performance in the league, general up to date sports news, individual player game statistics, and upcoming games etc. while the game they are attending is being played in the sports arena that would otherwise not be able to display all of the above information to the sports viewer inside the stadium.

### BRIEF DESCRIPTION OF THE DRAWING

For a fuller understanding of the nature and objects of the invention, reference should be had to the following detailed description taken in connection with the accompanying drawing of this specification and in which similar numerals of reference indicate corresponding parts in all the figures of the drawing:

FIG. 1 is a flat rear view of an embodiment of the present invention.

FIG. 2 is a broad view of the embodiment of FIG. 5.

FIG. 3 is a sample front view displayed by the device of this invention.

FIG. 4 is a flat front view of an embodiment of the present invention.

FIG. 5 is a broad view showing the interrelationship of the various elements of the present invention.

### DESCRIPTION OF THE PREFERRED EMBODIMENT

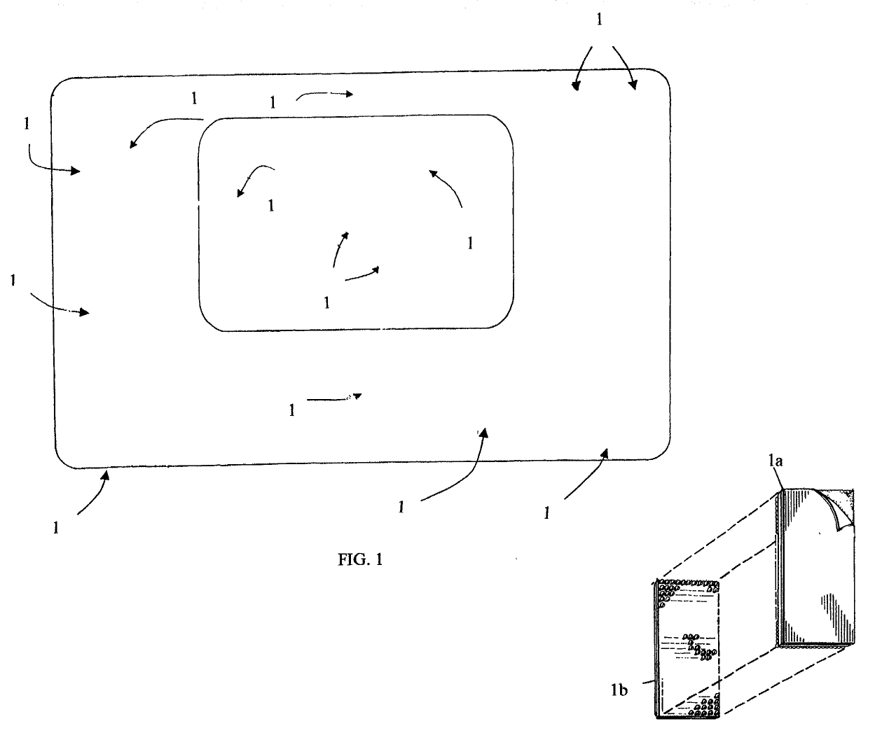

Referring to FIG. 1, an embodiment of the apparatus of the present invention is shown comprised of a dual lock fastener 1 fabricated of impact clear Acrylic adhesive that will adhere virtually to any surface. The shown case has a rectangular perimeter defined by having a higher tensile and shear strength than traditional hook and loop fasteners. The shown embodiment is also composed of a self-mating, which simply reattaches them when pressed together, and thousands of mushroom heads interlock with one another creating a snap that announces that the fastener is locked. The present embodiment 1b is considered the hook, which is the rough, or hard side, while the present embodiment 1a of the apparatus, is the soft or the fuzzy side.

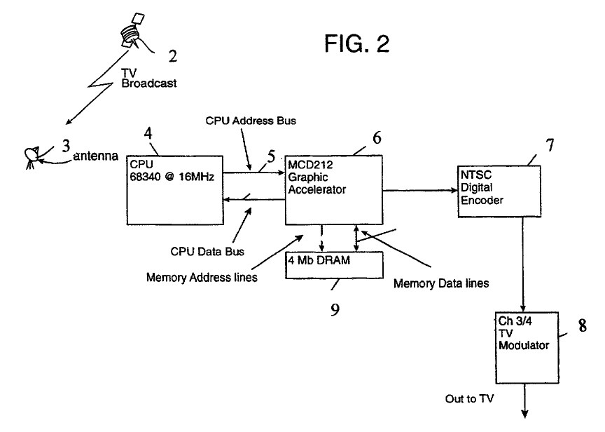

In FIG. 2 a TV broadcast satellite 2 of suspended buoyancy is substantially transmitting a signal from the sky on to the antenna 3 grounded on a frequency tune that sends the signal to a CPU that utilizes the transmission and coverts the signal to computer language via CPU address Bus 5 and feeds the signal on to a MCD 212 Graphic Accelerator 6 and then relays the signal to the NTSC Digital Encoder 7 of which is an entrical receiving input that the LCD screen 11. The next transmission is relayed to the Ch 3 or 4 TV modulator 8, which in turn ends the cycle at the TV, or in this case the LCD screen. The 4 MB DRAM 9 is important in the diagram because it sends and receives data to and from the MCD 212 Graphic Accelerator.

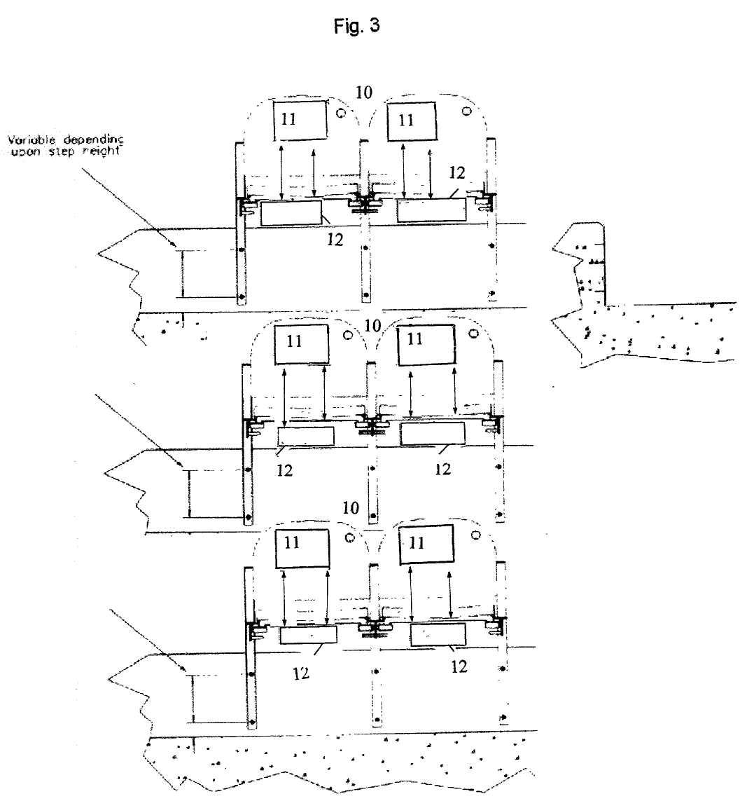

The FIG. 3 shown contains a front view displayed by the device of this invention. The stadium seats 10 that encompass the present invention, are arranged as if they were in designated areas that show the embodiment of the LCD television screen 11, that is mounted on the upper back of the stadium seat in order for the viewer to enjoy the telecast from behind the person sitting in front of them which has the LCD television screen mounted on the upper back of their particular seat in the stadium This is a simple illustration that represents the seating at the beginnings of each designated row for viewers to purchase the viewers' tickets. The LCD television screens are connected to the satellite receivers 11 with coaxial cables that enable the LCD screens 11 to be used for slaving and therefore using the same subscription rate from the satellite-based company provider. The satellite-based company offers an oval dish, which is composed of two inputs and four outputs for the LCD screens 11. This enables the receiver 11 to be more easily connected to more LCD screens because the connections are made from one source instead of many just as a connection that utilizes two inputs with a splitter that carries one RCA cable into each output on the LCD television screen. The average receiver 12 provided by the satellite service provider is (two inputs and one output).

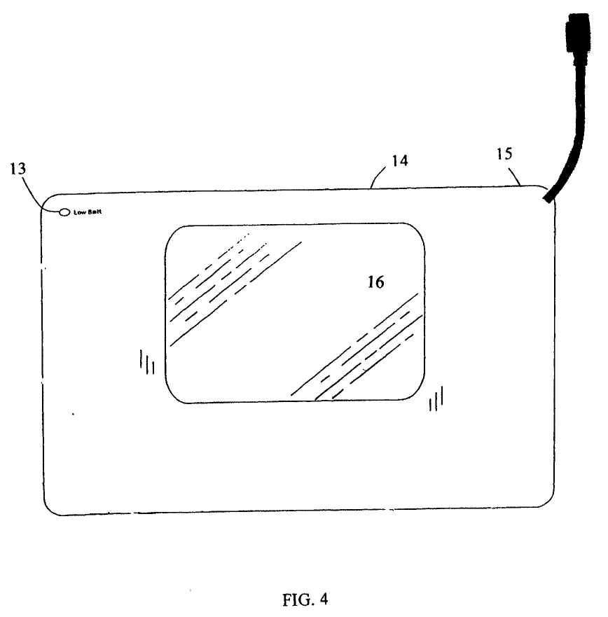

FIG. 4 is a flat frontal view of an LCD television screen 11, which is comprised in the diagram with a plastic harness usually with a 1¼″ mounting depth often a thin profile and is used for mounting hardware and as a headrest bezel that fits inside an automobile usually behind the automobiles' headrest, or for mounting the LCD television on a dashboard as well. A 12-14.4 Volt DC Operation from the electrical current powers the power profile 15.

Battery operated LCD screens may carry a battery power level 13 to measure the power for the LCD television screen. The high resolution LCD screen 16 is capable of a wide viewing angle generated by a 5″ TFT Active Matrix screen that is comprised of around 224, 000 DPI or (Dots per Inch).

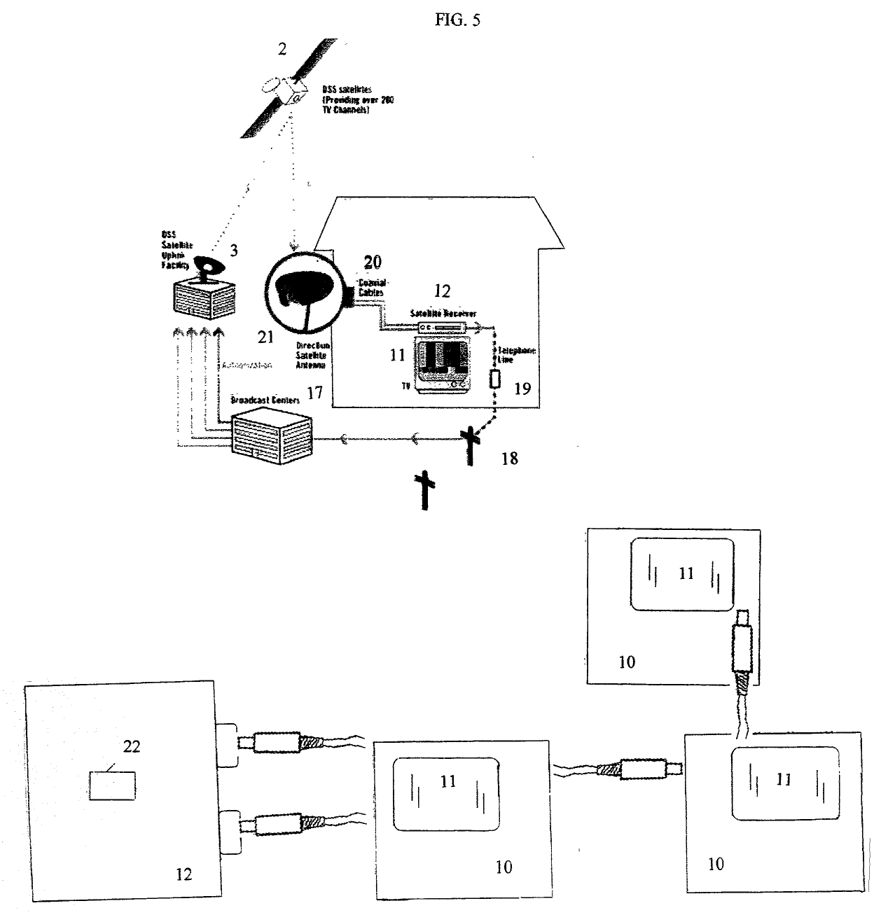

FIG. 5 is a broad view of how the present invention is interrelated between all of the above apparatus. The satellite signal 2 is beaming down on to both the satellite dish and the DSS Satellite Uplink Facility. The signal is carried first, to the small satellite dish 21 and then towards coaxial cables 20 which in turn are carried to the satellite receiver 12 to the television 11 (LCD screen), and on to a telephone line 19 which the signals are carried all around cities and states by power lines 18 to a Satellite Broadcast Center 17 that in turn direct the signal once again to the DSS Satellite Uplink Facility 3 that beams the signal back towards the satellite in the sky once again repeating the cycle over. FIG. 5 also shows the connection between the satellite receiver 12 and the LCD screens 111 from one screen to another with splitter cables that use one cable in to each output of the LCD screens that are mounted on the upper back of the stadium seats 10. The provided sports channels are accessed and changed along with picture quality, volume control, and contrast on the LCD screen 11, with a remote control 22 that is provided to the viewer. The remote control is positioned on top of the receiver 12, with said dual lock acrylic fastener 1.

While the particular examples of the present invention have been described and shown, it is apparent that changes and modifications may be made therein without departing from the invention in its broadest aspects. The aim of the appended claims therefore is to cover all such changes and modifications as fall within the true spirit and scope of the invention.

1. An apparatus consisting of an LCD (Liquid crystal display) of rectangular contour connected to a receiver that transmits a signal from a small satellite dish and is in-use when viewing televised sports programming inside a, said sports stadium setting comprising:
a) An LCD (Liquid crystal display) mounted directly behind the seat of a person that is seated inside a sports stadium to attend a sports event, of which the seated row sections inside the sports stadium are designated for such apparatus,
b) LCD screens are attached to the said behind designated seats with a strong type of Velcro adhesive,
c) Receivers provided by a satellite-based company which are installed along with the small dish satellite at a sports stadium enable the specific televised sports event to be viewed inside the sports arena,
d) The said receiver transmits a satellite signal to the particular LCD screen via RCA cables which contain input and output on both the LCD screen and receiver,
e) The said receivers provided by a satellite-based company are positioned under the viewers' seat along with the receiver channel changer attached to the receiver with Velcro connecting the two together and therefore allowing the viewer to select the sports channel broadcast they are attending live, or the game(s) they so choose.

2. The apparatus LCD television screen of claim 1 wherein the screen is powered by a 12 to 14 AC current.

3. The apparatus of claim 2 wherein said the screen is powered by a 12 to 14 volt AC current is plugged in to an AC circuit breaker that plugs in to another electrical source inside the sports facility.

4. The apparatus of claim 3 further comprising an LCD television screen that is typically from said 5×4×1 to 7×6×3, of which has two RCA inputs and outputs that feed the signal from another antenna, cable, or satellite.

5. The apparatus of claim 1 wherein said receiver is available to the consumer only for sports related games that are broadcasted to them in particular via the said small satellite dish that feeds the transmission towards the receiver and then the LCD television screen inside the sports arena.

6. The apparatus of claim 1 further provided with means for programming the said receiver to only show the sports televised channels therefore blocking all other channels from viewing.

7. The apparatus of claim 1 further provided with means for installation of small dish satellite being the same standard installation they operate with.

8. The apparatus of claim 1 further provided with operating needs with said viewer and LCD television screen by the viewer already finding the LCD screen on and already broadcasting sports news information, or video feed from the actual game attended in the same stadium therefore allowing the viewer to operate the said apparatus by only changing the sports channel with said channel changer, adjusting the volume, and the brightness control level displayed on the front of the LCD screen.
The apparatus of claim 1 wherein said seated row sections inside the sports stadium are designated for such apparatus needs are directly stipulated to the potential viewer of the LCD screens, that they must sign a brief agreement and give identifiable information in order for the viewer to be responsible at the end of the game for the LCD screen in case some intentional damage or stolen property occurs at that particular seat after the game.

9. The apparatus of claim 1 wherein said seated row sections inside the sports stadium are designated for such apparatus gets the viewers awareness to please not touch the LCD screen with peal-off stickers that read, please don't touch the screen.

10. The apparatus of claim 1 wherein said seated row sections inside the sports stadium are designated for such apparatus allow the viewer that attends regular games at the particular sports arena, to purchase a LCD “Game Viewer's Pass” with advance sales purchase to avoid sell out designated LCD viewing sections.

11. The apparatus of claim 10 wherein said viewer that attends regular games at the particular sports arena allow the viewer to purchase in advance with their Season tickets pass, with advance tickets sales, through the sports event team website, or by simply buying the advance viewing tickets if they don't want to wait for an available designated section.

12. The apparatus of claim 1 wherein said LCD (Liquid crystal display) of rectangular contour which represents the viewer with prior knowledge of the above service rendered before attending the sports event by either paying at the ticket office for their designated ticket seated section that renders the above apparatus, or by the company creating awareness of the service apparatus.

13. The apparatus of claim 1 further comprising of audible capabilities from the LCD screen itself, or from an outside source such as a mini-speaker(s).

14. The apparatus of claim 1 further comprising of a satellite-based company, which installs a small satellite dish and receiver(s) towards any television(s) at home or at a business, is the same installation used for the above apparatus.
